(19) United States
(12) Patent Application Publication
(10) Pub. No.: US 2009/0303521 A1
(43) Pub. Date: Dec. 10, 2009

(54) METHOD AND SYSTEM FOR SHARING OF A USB PRINTER TO ALL CLIENTS

(75) Inventor: G. Shravan Kumar, Andhra Pradesh (IN)

Correspondence Address: LOWE HAUPTMAN HAM & BERNER, LLP, 1700 DIAGONAL ROAD, SUITE 300, ALEXANDRIA, VA, 22314, US

(73) Assignee: MOSCHIP SEMINCONDUCTOR TECHNOLOGY LIMITED, Hyderabad (IN)

(21) Appl. No.: 12/134,518

(22) Filed: Jun. 6, 2008

(51) Int. Cl. G06F 15/00

(52) U.S. Cl. 358/1.15

(57) ABSTRACT

Embodiments herein disclose a method of a client PC virtualizing a USB printer present on the network, only when a print job is given to the client PC and freeing the USB printer as soon as the print job gets over, hence making the USB printer available to other client PCs present on the network. A USB Printer connected to a USB Server in a network can be shared among multiple Client PCs available on the network where the client PCs are running on a Windows platform.

### BACKGROUND

1. Technical Field

The embodiments herein generally relate to USB printer device, particularly to USB printer device connected to a USB server device, and more particularly sharing of USB printer device connected behind a USB server device to multiple client computers available on the network.

2. Description of the Related Art

As the size of network system increases from a few connected computers located near each other to several thousand machines of various types, the demands on the network printers also increase. A printer is a peripheral device that can be shared on a network connected to a print server. In all existing network printer technologies, print servers are shared among multiple client computers on the network.

In accordance with prior art, the print server runs the print driver for the printer locally on the print server device. The print server is in communication with USB printer and network. The network is in communication with print server and client computers. The main drawback of print server device is that the print server requires the effort of porting the printer client drivers to the print server device, to support any new printer.

Universal Serial Bus (“USB”) printer is treated as an exclusive device available to only one computer in windows platform. A USB printer connected on a network behind a USB server device has been observed to have a number of associated problems. The most significant problem of the USB printer connected behind a USB server device available on a network is the difficulty in sharing among multiple client computers. The drawback of USB printer network system is inherent nature of all USB printers and it allows only one computer exclusively to use them. So, if one computer has connected to the USB server and taken ownership of the printer device, another computer can not use it.

If any one of the client wants to use USB printer, the client needs to virtualize the USB printer. Virtualizing means loading USB printer client drivers for the device that is not physically connected to the computer. The shortcoming of typical USB printer networks arises in those cases in which once an USB printer has been virtualized, all other clients on the network see the USB printer as busy and are not able to issue print job. More particularly, unless client frees the USB printer, no other client can use USB printer, even though it is not being used by the client.

### SUMMARY

In view of the foregoing, an embodiment herein provides a method of sharing a USB printer on a network, where the USB printer connected to a USB server on the network, the method comprising steps of an admin utility creating a printer monitor thread for the USB printer; the printer monitor thread monitoring a print spooler; the printer monitor thread detecting arrival of a print job from a device on the network on the printer spooler; the printer monitor thread sending a device plugin request to virtual bus driver of the device; the virtual bus driver virtualizing the USB printer, if the USB printer is available; the printer monitor thread detecting departure of a print job notification from a device on the network on the printer spooler; the printer monitor thread sending a device unplug notification to the virtual bus driver of the device; and the virtual bus driver of the device releasing the USB printer to the network, on receiving the device unplug notification. If the printer is busy, then the virtual bus driver periodically polls the USB printer, till the printer becomes free. The virtualization of the USB printer on the device comprises the steps of loading client drivers of the USB printer on the device; virtual bus driver of the device establishing a TCP connection with the USB server and the USB server opening a communication channel to communicate with the USB printer. The client drivers of the USB printer are unloaded from the device on receiving the device unplug notification.

Embodiments herein further disclose a method for sharing a USB printer on a network, the USB printer connected behind a USB server device to multiple devices available on the network, the method comprising the step of a device a device virtualizing the USB printer on being given a print job by the device; and the device unloading the USB printer on completion of the print job. Virtualization of the USB printer on the device comprises the steps of loading client drivers of the USB printer on the device; virtual bus driver of the device USB Server establishing a TCP connection with the USB server; and the USB server opening a communication channel to communicate with the USB printer.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following description with reference to the drawings, in which:

FIG. 1 illustrates a printer server system, in accordance with prior art;

FIG. 2 illustrates a USB printer network system, according to embodiments disclosed herein;

FIG. 3 illustrates virtual bus windows client software components in accordance with embodiments disclosed herein;

FIG. 4 illustrates a printer monitor thread block diagram in accordance with embodiments disclosed herein; and

FIG. 5 illustrates a flow chat of printer monitor thread in accordance with embodiments disclosed herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

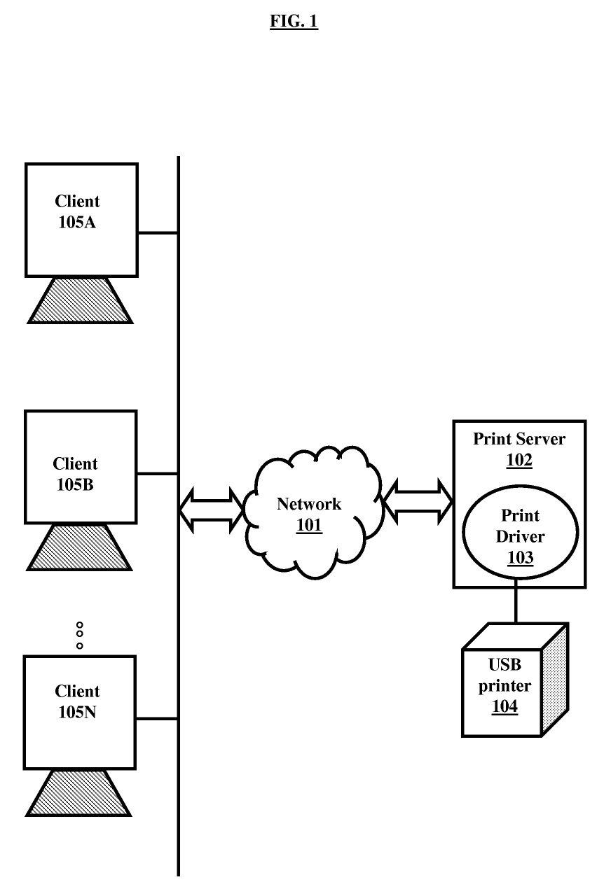

The embodiments herein achieve a method and system for sharing of USB printer connected behind a USB server to multiple client computers available on the network by providing a print client driver on client computers, loading printer client drivers only when a print job is given by client and unloading printer client drivers as soon as the print job is over. Referring now to the drawings, and more particularly to FIGS. 1 through 5, where similar reference characters denote corresponding features consistently throughout the figures, there are shown preferred embodiments.

Embodiments herein disclose a method of a client PC virtualizing a USB printer present on the network, only when a print job is given to the client PC and freeing the USB printer as soon as the print job gets over, hence making the USB printer available to other client PCs present on the network. A USB Printer connected to a USB Server in a network can be shared among multiple Client PCs available on the network where the client PCs are running on a Windows platform.

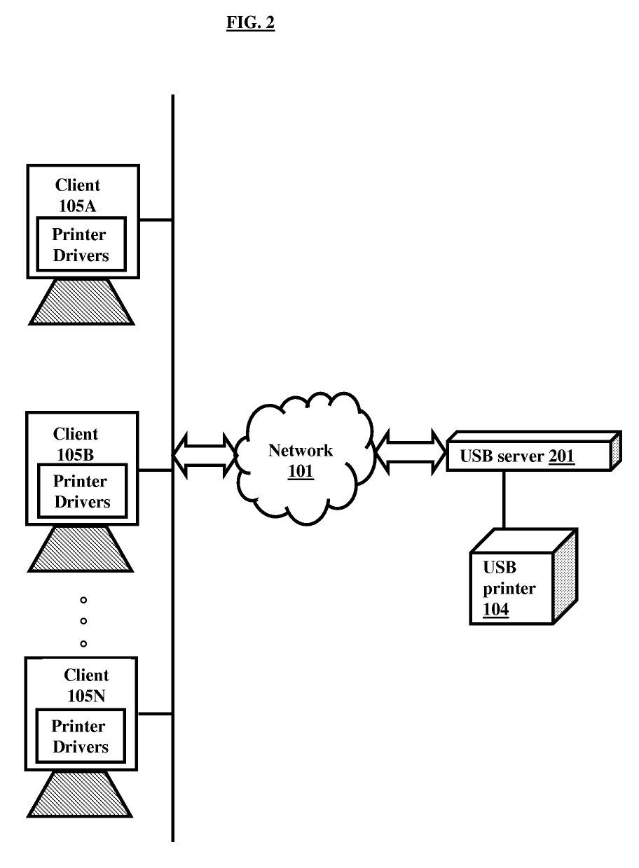

FIG. 2 illustrates a USB printer network system, according to embodiments disclosed herein. FIG. 2 comprises of an USB server 201, a network 101, an USB printer 104 and client PCs 105A-N. FIG. 2 illustrates sharing of the USB printer 104 attached to a USB server 210 to multiple client PC'S 105A-N available on the network 101 on a windows platform. The USB printer 104 is connected on the network 101 behind the USB server 201 device is virtualized on a PC. When any one of the Client PCs 105A-N wants to use the USB Printer 104, the client PC has to virtualize the USB printer 104. Virtualizing is, loading the USB printer client drivers for the USB printer 104 on the client PC, when the USB printer is not physically connected to the client PC. When a device is virtualized, a TCP connection is established with the USB Server 201. The TCP connection opens a communication channel to communicate with the USB printer 104 attached to the USB Server 201. This is achieved by Virtual Bus driver software, which is installed on the client PCs 105A-N.

When the USB printer 104 is virtualized by a client PC, all other client PCs present on the network 101 will see the USB Printer 104 in busy state and as a result other client PCs will not be able to virtualize the USB printer 104 to issue a print job. Once the client PC, on which the USB printer 104 has been virtualized, has completed the print job, on hand, the USB printer 104 is unloaded and is made available for other client PCs on the network 101. For example when a print job is given from any one of the client PCs, the client PC takes control of the USB Printer 104 by virtualizing the printer and as soon as the print job gets over the client PC releases the printer for any one of the other client PCs on the network 101.

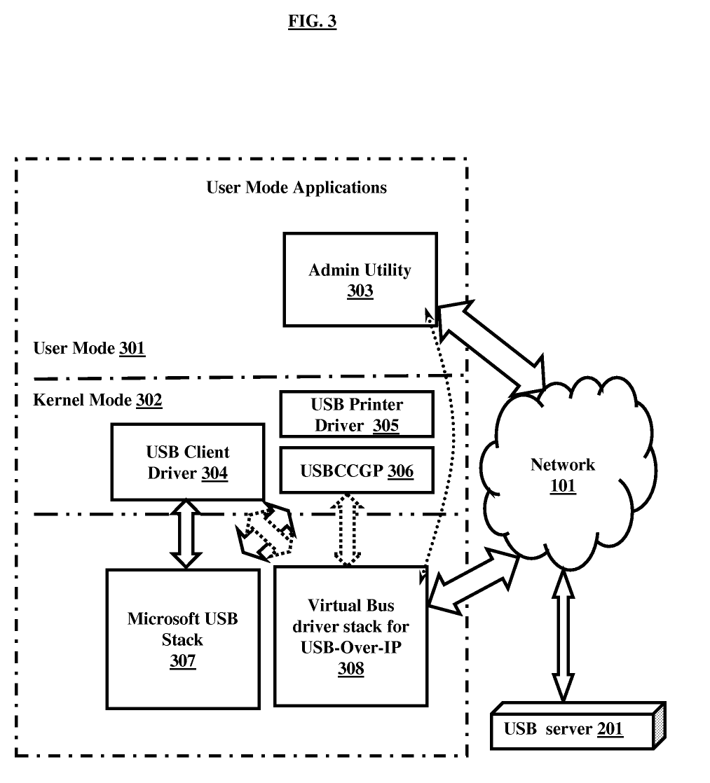

FIG. 3 illustrates virtual bus windows client software components in accordance with embodiments disclosed herein. FIG. 3 comprises of an user mode 301, a kernel mode 302, an admin utility 303, an USB client driver 304, an USB printer driver 305, an USB Common Class Generic Parent Driver (USBCCGP) 306, an virtual bus driver for USB-over-IP 308, a Microsoft USB stack 307, the network 101, and the USB server 201. FIG. 3 displays two modes of operation i.e. user mode 301 and the kernel mode 302. The admin utility 303 present in the user mode 301 provides UI to see various devices attached to the USB server 201 present on the network 101. Further the admin utility 303 provides a facility to connect/disconnect a device and virtualize the device attached to the USB server 201. The admin utility 303 also configures the USB printer 104 in printer sharing mode and achieves the USB printer sharing functionality. The USB server 201 is an embedded controller implementing an USB host controller and the network port 101. The virtual bus driver present in the kernel mode 302 helps in virtualizing the USB devices attached to the USB server 201.

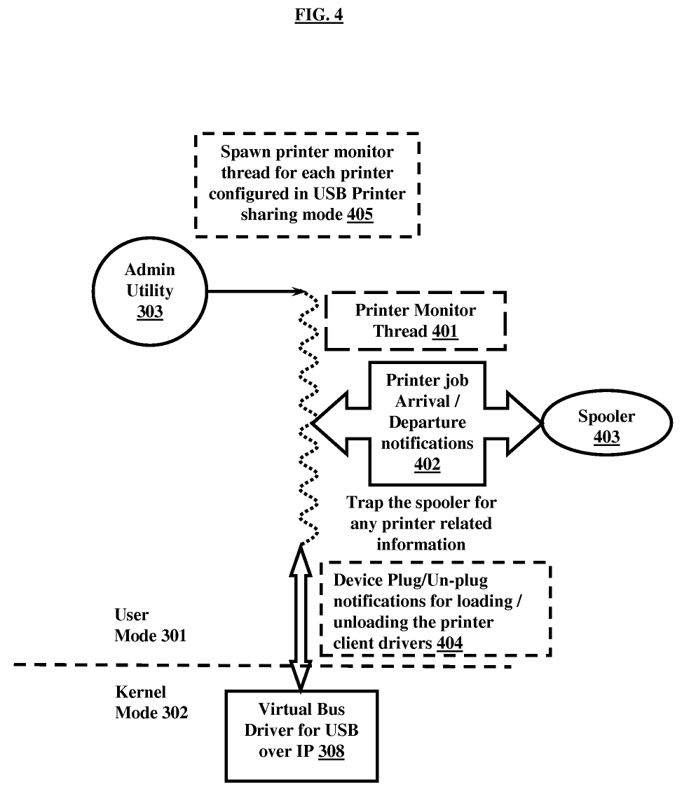

FIG. 4 illustrates a printer monitor thread block diagram in accordance with embodiments disclosed herein. FIG. 4, comprises of the admin utility 303, a printed monitor thread 401, a printer job arrival/departure notifications 402, a spooler 403, a device plug/un-plug notifications for loading/unloading the printer client drivers 404, a Spawn printer monitor thread for each printer configured in USB Printer sharing mode 405 and the virtual bus driver for USB over IP 308. FIG. 4 represents various components involved in Windows client S/W for Virtualizing USB Devices and for USB Printer sharing. USB Server is an embedded controller implementing a USB Host Controller and a network port. The Virtual bus driver 308 is a kernel mode driver, which helps in virtualizing the USB Devices attached to the USB-Server. The admin utility 303 provides UI from where you can see various devices attached to the USB Server 201 present on the network 101. Using the admin utility 303, one can connect/disconnect a device and virtualize a device attached to the USB Server 201. Admin utility 303 also helps in configuring the USB printer 104 in printer sharing mode and achieving the USB printer sharing functionality. Admin utility 303 interacts with the “Spooler”, a component of windows operating system, to find out the print job statuses. Admin utility 303 spawns a “Printer Monitor Thread” 401 for each USB printer. The printer monitor thread 401 will interact with the spooler 403 and gets to know about print job arrival and departure notifications. Microsoft provided API functions to interact with the spooler component to get to know about the job information. User can give/cancel a print job on the off line printers. When ever the printer monitor thread 401 sees a print job arrival notification, it will send a device plug in request to the virtual bus driver 308. The virtual bus driver 308 will negotiate for access to the USB printer 104 and takes the ownership of the USB printer 104, if the printer is free. If the USB printer 104 is busy, the virtual bus driver 308 will periodically poll the USB printer 104 to check if the printer is free. When the printer monitor thread 403 sees a print job departure notification, the thread will send a device unplug notification to the virtual bus driver 308. The virtual bus driver will release the owner ship of the USB printer and makes the printer free for other client PCs on the network 101 to use.

The pseudo-code for a method of sharing the USB printer over a network with multiple client PCs is as follows:

```
  DWORD WINAPI PrinterMonitor(LPVOID pnPrinterIndexParam)
    {//Get a handle to the specified printer using OpenPrinter( ) API..
    //Get the printer info by using the above handle to GetPrinter( ) API.
    //Very whether it is a new job
    //Issue plug in device request to virtual bus driver, for loading the
USB Printer client drivers
    //Verify whether the job is complete or not.
    //Issue unplug device request to virtual bus driver, for unloading the
USB Printer client driver.}
```

Following are the variables and data structures defined for achieving the USB printer sharing functionality

```
  //List to stores printer info configured in printer sharing mode
  CList<PRINTER_SHARING_LIST, PRINTER_SHARING_LIST>
  m_Printer_UpdatedInfoList;
  //USB Printer sharing related functions
  PRINTER_{—} SHARING_LIST
  m_ArrPrinter_PermanentInfo[MAX_ARRAYELEMENTS];
  //Holds printers list to be monitored or not
  typedef struct _PRINTER_SHARING_LIST_{—}
```

| | | |
|---|---|---|
| {CString | szPrinterName; | //Name of the printer assigned by |
| | | windows |
| BOOL | bMonitor; | //Flag tells whether to monitor this or not |
| USHORT | usVid; | //Vendor ID |
| USHORT | usPid; | //Product ID |
| USHORT | usRev; | //Revision |

| | |
|---|---|
| ULONG | ulServerIp; //IP address of the server, where the device is |
| connected | |
| USHORT | usPortNo; //Device connected to which port of server} |

PRINTER_SHARING_LIST, *PPRINTER_SHARING_LIST;

Following is the routine involved in achieving the USB printer sharing. //Thread function which monitors particular printer.

DWORD WINAPI PrinterMonitor(LPVOID pnPrinterIndexParam);

Calls Involved are as follows. Following Print APIs of Microsoft defined in “WinSpool.h” are used to achieve the USB Printer sharing functionality. The OpenPrinter function retrieves a handle to the specified printer or print server or other types of handles in the print subsystem

| BOOL OpenPrinter( | |
|---|---|
| LPTSTR pPrinterName, | // printer or server name |
| LPHANDLE phPrinter, | // printer or server handle |
| LPPRINTER_DEFAULTS pDefault | // printer defaults |
| ); | |

The GetPrinter function retrieves information about a specified printer.

| | |
|---|---|
| BOOL GetPrinter( | |
| HANDLE hPrinter, | // handle to printer |
| DWORD Level, | // information level |
| LPBYTE *pPrinter, | // printer information buffer |
| DWORD cbBuf, | // size of buffer |
| LPDWORD pcbNeeded | // bytes received or required |
| ); | |

The ClosePrinter function closes the specified printer object.

| | |
|---|---|
| BOOL ClosePrinter( | |
| HANDLE hPrinter | // handle to printer object |
| ); | |

Following printer related structures of Microsoft defined in “WinSpool.h” are used to achieve the USB Printer Sharing functionality.

```
typedef struct _PRINTER_INFO_2A {
  LPSTR  pServerName;
  LPSTR  pPrinterName;
  LPSTR  pShareName;
  LPSTR  pPortName;
  LPSTR  pDriverName;
  LPSTR  pComment;
  LPSTR  pLocation;
  LPDEVMODEA pDevMode;
  LPSTR  pSepFile;
  LPSTR  pPrintProcessor;
  LPSTR  pDatatype;
  LPSTR  pParameters;
  PSECURITY_DESCRIPTOR pSecurityDescriptor;
  DWORD  Attributes;
  DWORD  Priority;
  DWORD  DefaultPriority;
  DWORD  StartTime;
  DWORD  UntilTime;
  DWORD  Status;
  DWORD  cJobs;
  DWORD  AveragePPM;
} PRINTER_INFO_2A, *PPRINTER_INFO_2A,
*LPPRINTER_INFO_2A;
```

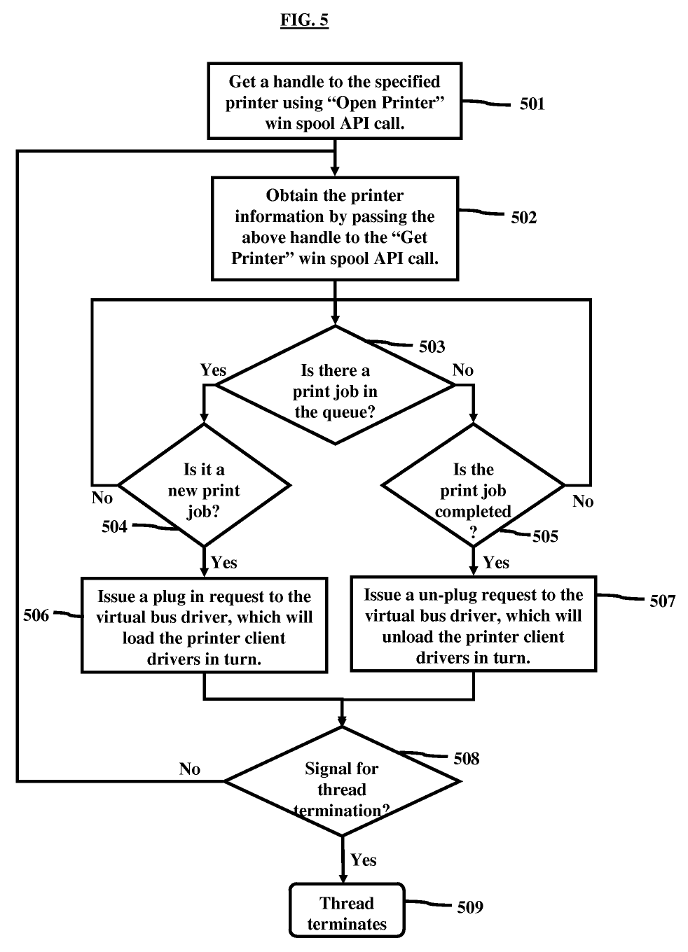

FIG. 5 illustrates a flow chat of printer monitor thread in accordance with embodiments disclosed herein. A handle to the specified printer is obtained (501) using “open printer” win spool API call. The printer then obtains information by passing (502) the above handle to the “get printer” win spool API call. Further the printer monitor thread determines (503) if there is any print job in the queue. If there is a print job then the printer monitor thread further determines (504) if the print job present in the queue is a new job. If the print job in the queue is not a new print job, then the printer monitor thread goes back to checking the queue for print jobs. If the print job in the queue is a new print job, then the virtual bus driver is issued (506) a request to virtualize the USB printer on the client PC from which the print job command was given. If there was no print job in the queue then the printer monitor thread further determines (505) if the print job is complete. If the print job is complete then a un-plug request (507) is issued to the virtual bus driver to unload the printer client drivers from the client PC, where the USB printer had been virtualized. If the print job is not complete then the printer monitor thread reverts to checking the queue for print jobs. The printer monitor thread checks (508) if a signal for thread termination is available. If a signal for thread termination is available, the thread is terminated. If the signal for thread termination is not available, the printer once again obtains (502) information by passing the above handle to the “get printer” win spool API call. The various actions in method 500 may be performed in the order presented, in a different order or simultaneously. Further, in some embodiments, some actions listed in FIG. 5 may be omitted.

Embodiments herein disclose a method and system of sharing a USB printer over a network, where the network comprises of computing devices running Microsoft Windows. However, it is obvious to a person skilled in the art that the method as disclosed can be implemented on any network independent of the Operating System of the devices present on the network.

The embodiments disclosed herein can take the form of an entirely hardware embodiment, an entirely software embodiment or an embodiment including both hardware and software elements. The embodiments that are implemented in software include but are not limited to, firmware, resident software, microcode, etc.

Furthermore, the embodiments disclosed herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A method of sharing a Universal Serial Bus (USB) printer on a network, said USB printer connected to a USB server on said network, said method comprising steps of:
an admin utility creating a printer monitor thread for said USB printer;
said printer monitor thread monitoring a print spooler;
said printer monitor thread detecting arrival of a print job from a device on said network on said printer spooler;
said printer monitor thread sending a device plugin request to virtual bus driver of said device;
said virtual bus driver virtualizing said USB printer, if said USB printer is available;
said printer monitor thread detecting departure of a print job notification from a device on said network on said printer spooler;
said printer monitor thread sending a device unplug notification to said virtual bus driver of said device; and
said virtual bus driver of said device releasing said USB printer to said network, on receiving said device unplug notification.

2. The method of claim 1, wherein said virtual bus driver periodically polls said USB printer, if said USB printer is not available.

3. The method of claim 1, wherein virtualization of said USB printer on said device comprises the steps of:
loading client drivers of said USB printer on said device;
virtual bus driver of said device establishing a TCP connection with said USB server; and
said USB server opening a communication channel to communicate with said USB printer.

4. The method of claim 1, wherein client drivers of said USB printer are unloaded from said device on receiving said device unplug notification.

5. A system adapted to enable sharing of a USB printer on a network, said USB printer connected behind a USB server device to multiple devices available on said network, said system comprising at least one means adapted to
create a printer monitor thread for said USB printer;
monitor a print spooler;
detect arrival of a print job from a device on said network on said printer spooler;
send a device plugin request to virtual bus driver of said device;
virtualize said USB printer, if said USB printer is available;
detect departure of a print job notification from a device on said network on said printer spooler;
send a device unplug notification to said virtual bus driver of said device; and
release said USB printer to said network, on receiving said device unplug notification.

6. A method for sharing a USB printer on a network, said USB printer connected behind a USB server device to multiple devices available on said network, said method comprising the step of:
a device virtualizing said USB printer on being given a print job; and
said device unloading said USB printer on completion of said print job.

7. The method of claim 6, wherein virtualization of said USB printer on said device comprises the steps of:
loading client drivers of said USB printer on said device;
virtual bus driver of said USB Server establishing a TCP connection with said USB server; and
said USB server opening a communication channel to communicate with said USB printer.

8. A program storage device readable by computer, tangibly embodying a program of instructions executable by said computer to perform a method for sharing a USB printer on a network, said USB printer connected behind a USB server device to multiple devices available on said network, said method comprising the step of:
a device virtualizing said USB printer on being given a print job; and
said device unloading said USB printer on completion of said print job.
